(19) United States
(12) Patent Application Publication
(10) Pub. No.: US 2026/0155006 A1
(43) Pub. Date: Jun. 4, 2026

(54) DIGITAL SYSTEM WITH SMART PADLOCK FOR LOCKOUT AND TAGOUT OF HAZARDOUS ENERGIES

(71) Applicant: BSAFER SOLUÇÕES TECNOLÓGICAS PARA SEGURANÇA INDUSTRIAL LTDA, Araras (BR)

(72) Inventor: Ezequiel Damasceno DORNELAS, São José do Rio Preto (BR)

(21) Appl. No.: 19/123,570

(22) PCT Filed: Jul. 4, 2023
(86) PCT No.: PCT/BR2023/050230

§ 371 Date: Apr. 23, 2025

(30) Foreign Application Priority Data
Nov. 11, 2022 (BR) 1020220230838

(51) Int. Cl. G07C 9/00; G07C 9/38

(52) U.S. Cl. CPC G07C 9/00896; G07C 9/00674; G07C 9/00944; G07C 9/38; G07C 2009/00507; G07C 2009/00587; G07C 2009/00769

(57) ABSTRACT

A novel digital system with smart padlock for lockout and tagout of hazardous energies, used in industrial equipment and systems and composed of hardware and software, is based on the digital LOTO (LockOut & TagOut) platform, a method that guarantees zero energy at the energy points of machines and equipment in industry, of the energies that enable the operation of a machine, in combination with the labelling and tagging of said lockout to identify who is carrying out the activity on the equipment.

### BACKGROUND OF THE INVENTION

The present invention relates to a new Digital System with Smart Padlock (BSAFER) for lockout and tagout of hazardous energies, used in industrial equipment and systems and composed of hardware and software, said system based on the digital LOTO (LockOut and TagOut) platform, a method that guarantees zero energy at the energy points of machines and equipment in industry, of the energies that enable the operation of a machine, in combination with the labelling and tagging of said lockout to identify who is carrying out the activity of the equipment.

### FIELD OF THE INVENTION

The Digital System with Smart Padlock Bsafer for lockout and tagout of hazardous energies, object of the present invention, and used in mechanical, electromechanical and electronic equipment used in industries of in any field where it is necessary to control the energies that enable machine operation in combination with the digital tagging and identification of such lockout for the recognition of who is performing the activity on the equipment, aiming at occupational safety.

### OBJECTIVES OF THE INVENTION

The Digital System with Smart Padlock Bsafer for lockout and tagout of hazardous energies, object of the present invention, aims to offer to the relevant market a solution for the lockout and tagout of hazardous energies, both nationally and internationally, that is low-cost, efficient, effective and easy to use.

### PROBLEM TO BE SOLVED

The use of appropriate LOTO devices is essential to ensure a safe working environment. For this to be possible, employees need to be trained to follow the established lockout procedures, that is, training must be structured to ensure proper execution of the activity. The majority of accidents, whether near misses, with loss of limbs or even fatalities, are almost always correlated with the locking out of hazardous energies/signaling due to non-compliance or lack of procedures for the maintenance, cleaning, operation, removal/replacement of parts or due to entanglements inside the equipment and any other operation that may bring the operator into contact with the source of hazardous energies.

The lockout and tagout of hazardous energies is carried out in industries and companies of any size, whether small, medium or large. As these are requirements of national standards such as NR10, NR12 and international standards, such as OSHA Directive 2009/10/EC (Europe), EN ISO 1411/EC (Europe) among others, according to the regulations of each jurisdiction. This procedure, correctly executed, guarantees the safety of the workers involved in the services performed on the machines and equipment, such as product formats changes, cleaning, maintenance, inspection, among others.

The industry has the responsibility to ensure the safety of employees during interventions on machines, when they are not operating and are undergoing services performed on the machines and equipment, such as product formats changes, cleaning, maintenance, inspection, among other. Improper execution of the procedure may result in a risk to health and life of the employees involved in these tasks.

The padlocks, as well as the execution of the procedures themselves, currently used, are susceptible to being circumvented, either by easy unlocking of the padlock or lack of a digital record with the date and time of execution, which hinders investigations and audits. Another point that can be highlighted is the difficulty of execution due to the presence of several procedures in the area or even the ease of not following it faithfully (step by step/correct sequence), notwithstanding there is also the problem of outdated procedures or procedures developed with errors due to the lack of approval workflow of the procedures by specialized personnel. To avoid/eliminate these issues and, consequence, organically increase the safety level, facilitating use in the Gemba, personnel and process management; and contributing to a journey of interdependent safety culture, the Digital System (platform) with Smart Padlock Bsafer for lockout and tagout of hazardous energies, object of the present invention, was conceived.

When a LOTO procedure is not correctly performed, a machine or equipment may be accidentally reconnected, leading to accidents that can result in injuries, amputations and even death. Thus, this procedure is used to prevent opening of handles and handwheels of pneumatic, hydraulics, steam and closed products valves, the closing of drains, pipeline valves, the reactivation of breakers and disconnected electrical switches, and closing of open confined space hatches, among other applications. All to ensure the safety of workers involved in activities such as products format change, cleaning, maintenance, inspection, among others.

### STATE OF THE ART

There are some patent documents that describe LOTO procedure of security systems, however, none of these documents anticipate the system and its operation as described herein. Among these documents, the following can be highlighted:
The patent document EP3441949A1, LOCKOUT/TAGOUT SYSTEM, where the invention refers to a lockout/tagout system that has a lockout device (100), a master device (200) and a slave decide (300). The locking device (100) and the master device (200) are configured in a mutual relationship for duplex communication, so that the locking device (100) can unlock upon request received from the master device (200), dependent on an authentication protocol between the master device (200) and the locking device (100). The master device (200) and the slave device (300) are configured in a mutual relationship for duplex communication, so that the master device (200) receives a ‘clean’ request from the slave device (300), which is accepted by the master device (200) dependent on an authentication protocol between the master device (200) and the slave device (300);
The patent document US104605544B2, LOCKOUT/TAGOUT DEVICE WITH NON-VOLATILE MEMORY AND RELATED SYSTEM, which describes an intelligent lockout/tagout or isolation device that includes a wireless link, a non-volatile memory and a controller in communication with wireless link and the non-volatile memory. The wireless link is in selective communication with a wireless identification device, such as a key card, carried by a user. The controller is programmed to receive a signal from the wireless link and record usage information on the device in at least one part of the non-volatile memory, so that the part of the non-volatile memory that stores the usage information cannot be deleted or reactivated. written, securely storing this usage information. This intelligent lockout/tagout or isolation device can be standalone or part of a system that can potentially serves as part of an facility-wide security system (for example, networked or in communication with a SCADA system); and
The patent document U.S. Pat. No. 10,614,646B1, LOCKOUT/TAGOUT SYSTEM AND METHOD INCLUDING MULTI-USER LOCKOUT DEVICE WITH ELECTRONIC LOCKING AND WIRELESS CONTROL INTERFACE, where the lockout/tagout devices are configured to receive locking and unlocking commands generated electronically by multiple users thorough wireless interfaces in order to implement lockout safety chains of a desired length to ensure worker safety in an industrial system. Electronically implemented systems and methods are also disclosed, providing enhanced worker safety, increased security, and improved lockout/tagout supervision, involving a reduce number of locking devices and fewer complications compared to conventional lockout/tagout devices, systems, and processes.

### SUMMARY OF THE INVENTION

The Digital System with Smart Padlock for Lockout and Tagout Hazardous Energies, object of the present invention, is a digital LOTO system, which consists of a set of hardware and software comprising an electromechanical padlock (CE), its application for use (APP) and its operation as a digital system (PL, SD);

Wherein the padlock (CE) comprises; a locking shackle (1), shackle locking button (2); an upper base (3), shackle magnet support (4), cylindrical neodymium magnet (5), elliptical slider of the shackle locking button (6) located behind the shackle locking button (2); motor with mechanical gearbox (7), power supply batteries (8), a central support for the motor and board (9), circuit board (10), central locking support (11), translucent LED button housing (12), acrylic PIPE light button (13) and the locking body of the padlock assembly (14).

The padlock has a manual opening and closing mechanism, where through a button, the user can open and close the padlock as many times as they want and when they are sure of the location to be locked, they can lock the padlock through the Application (APP), which only allows locking after completing a lockout guide procedure, separated by energies, each energy has its own procedure, composed of a checklist on the activities performed and the double check by a second employee who will verify the procedure carried out. The sum of the procedure forms a Lockout Guide that can only be executed with the acceptance of a commitment term with the correct execution of the procedures/guideline.

To prevent the padlock from being forcibly opened, the mechanism includes the elliptical slider of the shackle locking button (6), which acts as a barrier that locks the padlock, preventing forced opening from happening. Only if the user breaks the padlock, will they be able to open it without using the APP. In this case, any possibility of mechanical opening in case of system failure is eliminated. If the system fails, the only way to open the padlock is cutting the shackle.

The mechanical barrier of the padlock, created by the elliptical slider of the shackle locking button (6), located behind the shackle locking button (2), prevents any attempt to force the shackle locking button (2) open the shackle, clogging the shackle (1). Thus, forced openings are prevented, and the lock can only be opened of padlock is destroyed.

Conventional padlocks only have a simple spring-loaded latch, and what prevents this latch from returning and opening the shackle is the spring, but with little effort and tools, the latch can be easily moved and the shackle opened, as there is no mechanical barrier beyond the force of the spring.

The execution of the locking is based on a guide customized by the company being a great differential, as it ensures that users perform the entire LOTO safety procedure, going through all energy points, when machines or equipment have more than one energy point.

The digital LOTO system operates as follows: initially, registrations are performed on the WEB Platform (uses, padlocks, Machines and Lockout Guides with the respective energies present in the machine and the types of activities the user is allowed to perform (Skills and Training Matrix—position definitions, permissions, among other), then the information registered on the WEB Platform is accessed by the APP for procedure execution, after the procedure is completed and the with the locking of the BSafer smart padlock, the APP sends the procedure history to the WEB Platform (Backend). Finally, this historical data storage allows management of ongoing and completed procedures, providing management and safety teams of industries with greater visibility into what is happening in the field, aiming to enhance control over the areas with the highest number of interventions versus the risk level associated with the energy source, machine or equipment.

In lockout cases, the electronics receive the lock command signal from the firmware and power the motor with mechanical gearbox (7), which rotates in the locking direction; and being coupled to the elliptical slider of the shackle locking button (6), it also rotates, creating a mechanical barrier (elliptical profile) behind the locking button (2), which can no longer be pressed, thereby preventing the shackle (1) from being removed from its housing, resulting in the locking of the padlock. The locking button (6) and the cylindrical neodymium magnet (5) are responsible for triggering the circuit board's locking sensor (10), which confirms that the process has been successfully completed and sends the lock confirmations to the APP. In cases where more than one employee is performing the lockout on a single energy point, machine, or equipment, the system performs a Check-in to the lock, whereby the lock performs a second lock in the system—without any electronic or mechanical action—only through software and firmware, as the BSafer smart padlock is already in the locked state.

### BRIEF DESCRIPTION OF THE DRAWINGS

Reference is now made to the drawing accompanying this descriptive report are shown below for better understanding and illustration:

FIG. 1—shows the flowchart of the operation of the Digital System with Smart Padlock for lockout and tagout of hazardous energies.

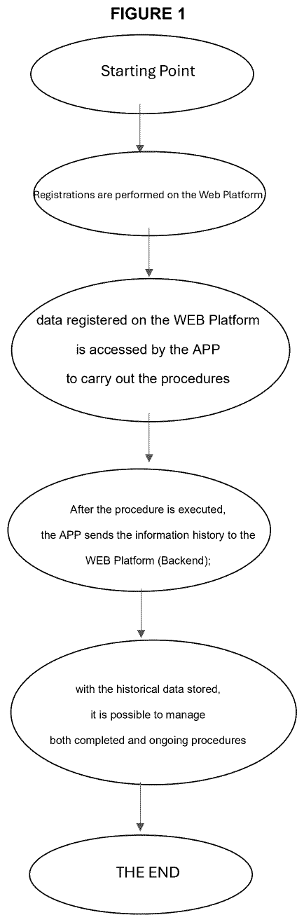

FIG. 2 shows a schematic of the Smart Padlock for lockout and tagout of hazardous energies, highlighting all its configuration details.

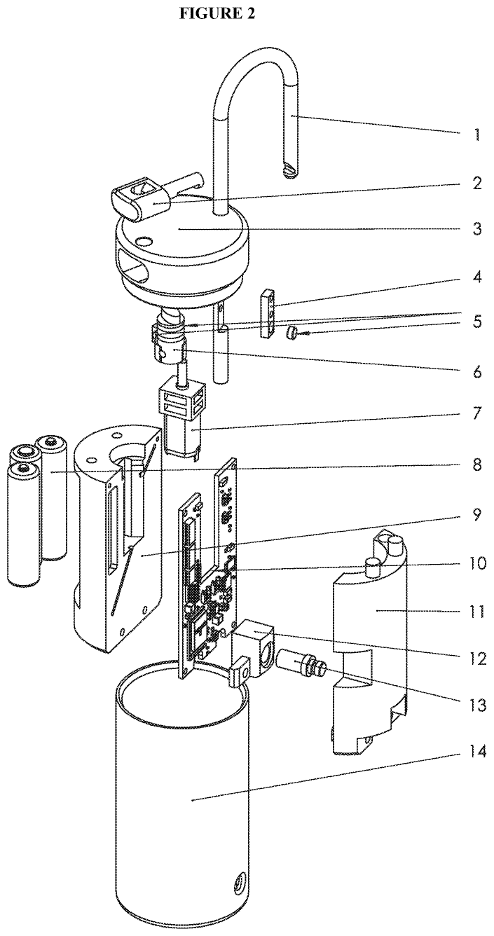

FIG. 3 shows the blocks diagram of the electronics of the Digital System with Smart Padlock for lockout and tagout Hazardous Energies.

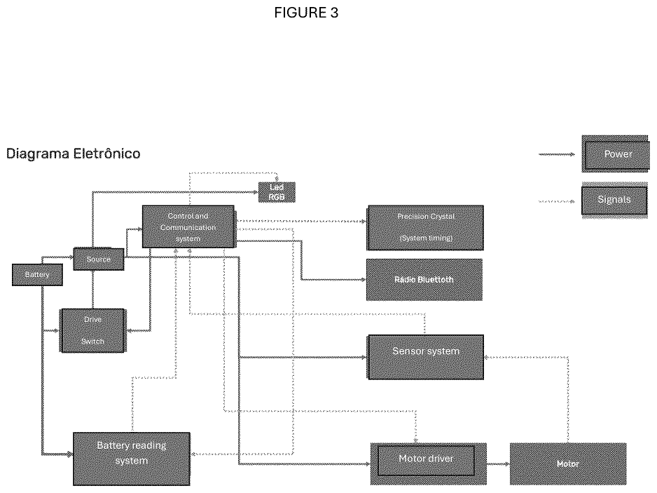

FIG. 4 shows the flowchart of platform operation of the Digital System with Smart Padlock for lockout and tagout Hazardous Energies.

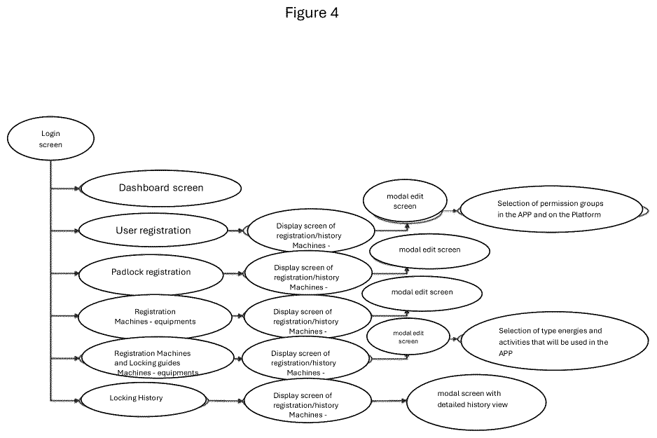

FIG. 5 shows the flowchart of application operation of the Digital System with Smart Padlock for lockout and tagout Hazardous Energies.

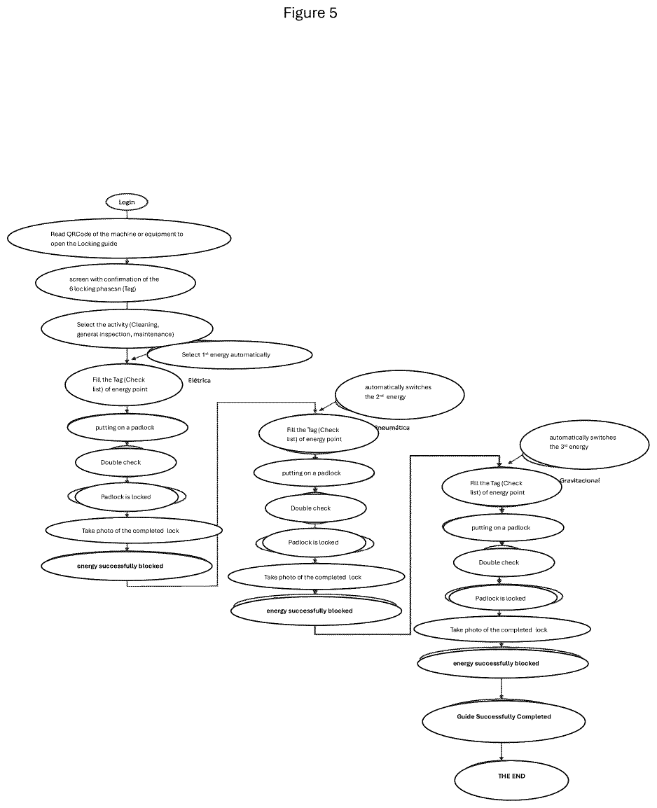

FIG. 6 shows the flowchart of the operation of the padlock for lockout and tagout Hazardous Energies

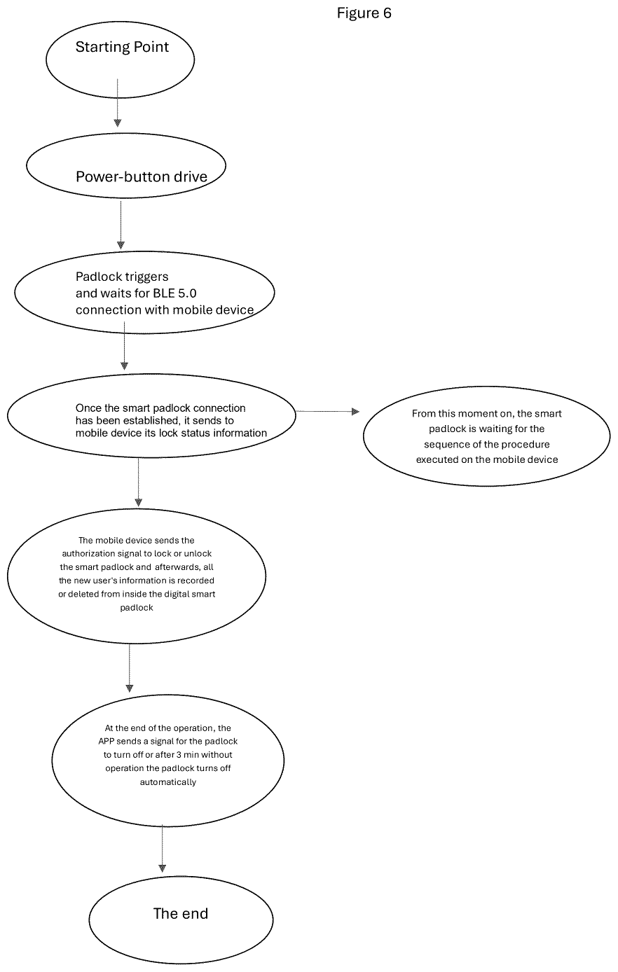

### DETAILED DESCRIPTION OF THE INVENTION

The operation of the Digital System with Smart PadLock BSafer for the Lockout and Tagout of Hazardous Energies, object of the present invention, is carried out as follows:
The user logs into the WEB platform and registers users, padlocks, machines, and Lockout Guides with the respective energy sources present in the machine and the types of activities the user may perform (Skills and Training Matrix), role definitions, permissions, among others; the user prints the QRCodes of the machines and affixes the QRCodes to their respective machines; the user logs into the APP and initiates a lockout process; the user scans the QRCode of the machine to be locked—the QRCode brings the machine information; the user selects the activities to be performed on the machine (cleaning, inspection, lubrication, maintenance, etc.); and the user carries out the lockout procedure and the installation of the BSafer smart padlock with the following actions:
The padlock is opened by pressing the shackle locking button (2) with the thumb. At this point, the component locking shackle (1) is released from its locking housing, and the BSafer smart padlock can be positioned at the desired lockout point; The User closes the locking shackle (1) again in its locking housing and the padlock remains at the point to be locked; The padlock can be locked internally if the shackle sensor is being triggered by the shackle magnet support (4) and the cylindrical neodymium magnet (5); if the shackle (1) is not properly housed, the shackle magnet support (4) and the cylindrical neodymium magnet (5) will not be triggering the shackle sensor in the electronics, which prevents the padlock from being locked by the locking system.

Then, the User fills out the checklist for the energy being locked out. Another User verifies what was done and the checklist; the User scans the QRCode of the padlock to be secured or to perform a check-in (“second lock/interlock” on a padlock that is already locked); the User powers the padlock via the power button; the mobile phone is connected to the padlock via Bluetooth (BLE5.0) through the APP; the APP and padlock communicate and exchange data; the APP sends the lock or check-in command from the user; finally, the padlock receives the data and processes the command.

In lockout scenarios, the electronics receives the lock command signal from the firmware and powers the motor with mechanical gearbox (7), which rotates in the locking direction; and as it is connected to the Elliptical Slider of the Shackle Locking Button (6), it also rotates, creating a mechanical barrier (elliptical profile) behind the Shackle Locking Button (2), preventing it from being pressed and thus preventing the locking shackle (1) from being removed from its housing, which results in the locking of the padlock. In this situation, the shackle locking button (6) and the cylindrical neodymium magnet (5) are responsible for activating the locking sensor, which confirms that the process was successfully completed. The padlock then sends lock confirmations to the APP, which saves the lockout data to the Backend via the internet and finalizes the procedure. If there is another energy source, the entire process is repeated. Whenever it is the last one, or in cases of being only energy source of the machine, the APP prompts the user to decide whether they want to perform another procedure or exit the APP. In check-in cases, the padlock performs a second lock in the system, without any electronic or mechanical action, only via software and firmware.

### ADVANTAGES

Thus, the Digital System with Smart PadLock for the Lockout and Tagout of Hazardous Energies, object of the present invention, features a new and unique configuration and operation that offers major advantages over padlocks currently available on the market for the same purpose. Among these advantages, the following can be highlighted: unlike existing padlocks on the market, which are locked simply by closing them through the force of a spring, the Smart PadLock presented herein is mechanically locked with a physical barrier provided by the Elliptical Slider of the Shackle Locking Button (6), positioned between the opening mechanism and the stroke of the shackle locking button (2), preventing the padlock from being forced open by trying to overcome the force of the spring, as occurs with padlocks currently on the market; the locking mechanist also ensures that the user cannot lock the padlock unintentionally, as locking only occurs after the signal is sent via the APP; lockouts are only carried out by properly registered and authorized employees, according to their Skills and Training Matrix within the BSafer Digital LOTO System, which guarantees the management and control of safety permissions within industries, which is essential to mitigate or even eliminate industrial accident rates; and, the fact that lockouts and interlocks are performed via software and firmware from a Lockout Guide customizable by company is the greatest differentiator, as we guarantee that users perform the entire LOTO safety procedure when machines or equipment have more than one energy source (lockout point).

Thus, due to the configuration and functional characteristics described above, it is clear that the DIGITAL SYSTEM WITH SMART PADLOCK BSAFER FOR THE LOCKOUT AND TAGOUT OF HAZARDOUS ENERGIES constitutes a new device and system in the State of the Art, incorporating elements of innovation, unprecedented inventive activity and industrial applicability, making it worthy of the Privilege of Patent for Invention.

1. A digital system with smart padlock for lockout and tagout of hazardous energies, wherein the digital system is a digital LOTO system, which consist of a set of hardware and software, comprising:
an electromechanical padlock;
a user application; and
an operation as a digital system,
wherein the padlock (CE) comprises:
a locking shackle;
a shackle locking button;
an upper base;
a shackle magnet support;
a cylindrical neodymium magnet;
an elliptical slider of the shackle locking button located behind the locking button;
a motor with mechanical gearbox;
a power supply batteries;
a central support for the motor and board;
a circuit board;
a central locking support;
a translucent LED button housing; and
an acrylic PIPE light button and the locking body of the padlock assembly.

2. The digital system according to claim 1, wherein the padlock features a manual opening and closing mechanism, where, via a button, the user can open and close the padlock as many times as desired, and when they are certain of the location to be locked, the user can perform the locking through the application, where locking only occurs after carrying out the procedure of a locking guide, divided by energy types, with each energy having its own procedure, composed of a checklist of performed activities and a double check by a second employee who will verify the procedure performed; where the sum of these procedures forms a Lockout Guide that can only be executed with acceptance of a commitment term with the correct execution of the procedures/guide, which is customizable.

3. The digital system according to claim 1, wherein preventing forced opening of the padlock, the mechanism though the elliptical slider of the shackle locking button, which functions as a barrier to secure the padlock.

4. The digital system according to claim 1, wherein the mechanical barrier of the padlock being carried out by the elliptical slider of the shackle locking button, arranged with the shackle lock button, prevents any attempt to force the shackle locking button; from releasing the locking shackle.

5. The digital system according to claim 1, wherein the digital LOTO system operating as follows: initially, registrations are carried out on the WEB Platform; then the data registered on the WEB Platform is accessed by the APP to carry out the procedures; after the procedure is executed, the APP sends the information history to the WEB Platform.

6. The digital system according to claim 1, wherein the padlock in lockout scenarios, the electronics receive the lock command signal from the firmware and power the motor with mechanical gearbox, which rotates in the locking direction; and being coupled to the elliptical slider of the shackle locking button, it also rotates, creating a mechanical barrier behind the locking button, which is then prevented from being pressed, and in turn the locking shackle is prevented from being removed from its housing, resulting in locking of the padlock; the shackle locking button and the cylindrical neodymium magnet are responsible for activation the locking sensor of the circuit board, which confirms that the process has been successfully completed and sends the locking confirmations to the APP; in check-in cases, a second lock is performed in the system, without any electronic or mechanical action.

7. The digital system according to claim 1, wherein the user logging into the WEB platform and registering users, padlocks, machines and Lockout Guides with the respective energy sources present in the machine and the types of activities the user can perform; the User prints the QRCodes of the machines and affixes the QRCodes to the respective machines; the User logs into the APP and initiates a lockout process; the User scans the QRCode of the machine to be locked—the QRCode brings the machine information; the User fills in which activities are to be performed on the machine; and the User performs the lockout procedure by installing the padlock at the energy blocking point; with these actions, the User fills in the checklist of the energy they are locking; another user verifies what was done and the checklist; the User scans the QRCode of the padlock to be locked or to perform a check-in; the User powers the padlock via the power button; the smartphone connects to the padlock via Bluetooth using the APP; the APP and the padlock communicate and exchange information; and the APP sends the lock or check-in command from the user; then the Padlock receives the data and processes it.
